(19) United States
(12) Patent Application Publication
(10) Pub. No.: US 2012/0089951 A1
(43) Pub. Date: Apr. 12, 2012

(54) METHOD AND APPARATUS FOR NAVIGATION WITHIN A MULTI-LEVEL APPLICATION

(75) Inventor: Brendon P. Cassidy, Los Angeles, CA (US)

(73) Assignee: CRICKET COMMUNICATIONS, INC.

(21) Appl. No.: 13/158,326

(22) Filed: Jun. 10, 2011

Related U.S. Application Data
(60) Provisional application No. 61/353,606, filed on Jun. 10, 2010.
(60) Provisional application No. 61/394,209, filed on Oct. 18, 2010.
(60) Provisional application No. 61/394,222, filed on Oct. 18, 2010.
(60) Provisional application No. 61/425,192, filed on Dec. 20, 2010.
(60) Provisional application No. 61/430,119, filed on Jan. 5, 2011.

(51) Int. Cl. G06F 3/048

(52) U.S. Cl. 715/854

(57) ABSTRACT

A processor in a computing system, such as a mobile device, can be configured to execute program instructions to provide an application having levels to which a user can navigate and in which a user can make selections to change the operation of the application. A navigation prompt provided by the application is selectable to produce a navigation interface with controls corresponding to different levels in the application. In some implementations, at least some of the controls can be labeled in accordance with selections made to navigate to the current level of the application. In other implementations, one or more of the controls can be labeled in accordance with how an item viewed at a current level of the application is categorized within the application hierarchy. Selection of a control in the navigation interface produces a new interface screen at a corresponding level of the application.

This application claims priority under 35 U.S.C. §119(e) to Provisional Patent Application No. 61/353,606 entitled “Unlimited Media Access Over Wireless Infrastructure” filed Jun. 10, 2010, to Provisional Patent Application No. 61/394,209 entitled “Mobile Handset For Media Access And Playback filed Oct. 18, 2010, to Provisional Patent Application No. 61/394,222 entitled “Media Server Providing Unlimited Media Access Over Wireless Infrastructure” filed Oct. 18, 2010, and to Provisional Patent Application No. 61/430,119 entitled “Method and Apparatus for Navigation Within A Multi-Level Application” filed Jan. 5, 2011, the contents of all four of which are incorporated herein by reference.

### TECHNICAL FIELD

The disclosed technology relates to improved techniques for navigation within a multi-level software application and in particular to navigation within multi-level software applications that run on mobile communications devices.

### BACKGROUND

In addition to allowing a user to initiate and receive telephone calls, most modern mobile communications devices also provide computing and entertainment functions. For example, mobile communications devices permit users to freely initiate and receive voice communications, e.g. through dial-up connections or push-to-talk. Further, mobile communications devices have been developed to provide users with access to data communications through wireless connectivity, such as over Institute of Electrical and Electronic Engineers (IEEE) 802.11 or 3G/4G networks. Data communications can provide a user with access to a wide variety of entertainment options, including audio, video, e-books, and gaming content as well as social networking functions.

Many software applications for mobile devices that provide these functions operate in a multi-level manner whereby a user can make selections within the program at a number of levels. These levels may be flat or can be hierarchical in nature, whereby selections at one level affect choices or selections at a lower level. In many instances, a user will want to navigate their way to a different level in the application in order to select a different setting or make different choices at a particular level. Traditionally, applications permit a user to navigate between levels using selections to move forward and a “back” control that sequentially shows the user each prior level through which they have navigated. In some instances, selections made by the user at any particular level are lost when the user moves from one level to another in the application. This can increase the time required for a user to change levels if content at each level must be downloaded from a remote site.

### SUMMARY

The disclosed technology is a system and method for navigating within an application program that includes one or more levels. The application program presents an interface display screen corresponding to a current level that includes a navigation prompt that can be selected by the user. Upon selection of the navigation prompt, a navigation interface containing a list of levels between a top level of the application and the current level is displayed. Each entry in the list is a control corresponding to a level of the application that can be selected to directly navigate to that level.

In one embodiment, each entry in the navigation interface shows selections made by a user at each of a number of levels as they navigated to the application's current level.

In another embodiment, some entries in the list are labeled within an indication of how a selection made at the application's current level is classified according to different levels of hierarchy. Upon selecting an entry, an interface screen for a new level can be presented that is configured in accordance with the label of the selected control.

In accordance with one embodiment, the application can provide a number of functional areas that allow a user to view, play, download and create playlists of media as well as access social networking functions. Each functional area can be associated with a color scheme such that an identifying color is associated with a particular functional area. The navigation interface produced by selection of the navigation prompt can be displayed using the color that corresponds to the functional area of the application from which the navigation prompt was selected. For instance, the color blue can be associated with a functional area in the media application corresponding to a local media catalog. When a navigation prompt is selected from within the local media functional area, the corresponding navigation interface can include the color blue to graphically identify that functional area.

### BRIEF DESCRIPTION OF THE DRAWINGS

FIG. 1 shows an exemplary computing environment in which media can be transferred to a mobile communications device.

FIG. 2 shows an exemplary mobile communications device.

FIG. 3 shows exemplary media interface screens associated with a multi-level media application that can be presented by a mobile communications device.

FIG. 4 shows a number of interface screens including an exemplary navigation interface associated with a multi-level media application in accordance with an embodiment of the disclosed technology.

FIG. 5 shows a number of interface screens including another exemplary navigation interface associated with a multi-level media application in accordance with an embodiment of the disclosed technology.

FIG. 6 is a flow diagram of a method of operating a processor within a mobile communications device to provide a multi-level media application with a navigation interface in accordance with one embodiment of the disclosed technology.

FIGS. 7A, 7B, 7C, 7D and 7E show exemplary navigations within various multi-level applications.

### DETAILED DESCRIPTION

The described technology for navigating within a multi-level application (e.g., hierarchical navigation) can allow a subscriber to determine his/her precise location within a navigational hierarchy by viewing the current status of the navigation path. Also, the described hierarchical navigation technology can allow a subscriber to navigate directly to any other level within the current navigation path.

Various user interfaces can be presented to allow a subscriber to activate various features of the described hierarchical navigation technology feature. For example, certain features can be activated responsive to subscriber selection of a navigation bar in an interface. The navigation bar can be color coded to indicate the logical context of the application within which the subscriber is navigating. Further, the navigation bar can be labeled with a name that identifies the corresponding level of the navigation hierarchy. For instance, an album or track name can be presented in the navigation bar.

In response to selecting the navigation bar, a navigation menu can be presented on the subscriber's computing device, such as a mobile device. The navigation menu can include a hierarchical list, showing the present hierarchical level and each hierarchical level above the present level. In some implementations, one or more lower hierarchical levels also can be presented, such as where the hierarchical tree does not have any additional branches.

The subscriber can select any of the hierarchical levels presented in the navigation menu, e.g., through touch input in a touch interface. In response to subscriber input, the application will navigate to the selected level.

These and other aspects of the described hierarchical navigation technology are described further below using various exemplary non-limiting embodiments and examples.

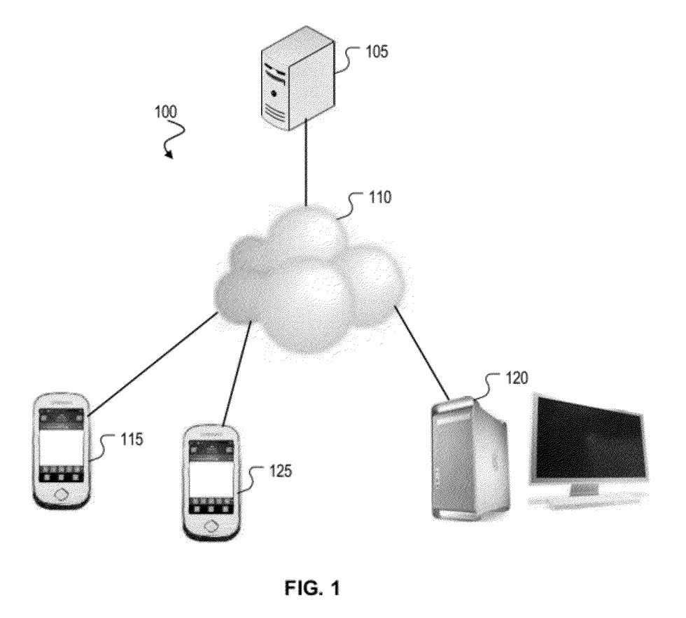

FIG. 1 shows an exemplary computing environment in which media can be transferred to a mobile communications device. Computing environment 100 can include a server 105 (or “the cloud”) configured to provide access to and management of media content. Server 105 can be implemented using a single computing device or multiple computing devices, which can be co-located or distributed across two or more locations. For instance, in some implementations, server 105 can be implemented using one or more application servers, web servers, and data servers, which can be housed in one or more locations.

Server 105 can host one or more applications configured to manage subscribing users. For instance, server 105 can be configured to validate a mobile communications device before the device is authorized to perform media related functions, including accessing locally stored media and downloading media from server 105. Further, server 105 can maintain an instance of one or more user accounts, including user account details, e.g. mobile identification number and subscriber name, locally stored music, subscribed play lists, managed play lists, play back history, and contacts. Server 105 also can host a media catalog (or media archive), which can be accessed through a subscribing mobile communications device in order to select media for download to the mobile communications device. Additionally, server 105 can be configured to manage the transfer of music to one or more subscribing mobile communications devices, including the transfer of specifically requested media and the automated transfer of media based on a subscription, e.g. to a play list.

Server 105 can be adapted to communicate with subscribing users over a network 110, which can be implemented using one or more data networks. For instance, network 110 can include either or both of wired and wireless communication links. Further, network 110 can be a public network, e.g. the internet, a private network, e.g. a cellular data network, or a combination thereof. Network 110 also can include one or more gateways, which facilitate the transfer of data between devices using different protocols. Further, network 110 can include either or both of secure links and unsecure links. Additionally, network 110 can include network infrastructure provided by multiple parties, such as a host network and one or more partner networks, e.g. roaming partners.

Mobile communications device 115, which is associated with a subscribing user, also can be configured to communicate over network 110, e.g. with server 105 and with other mobile communications devices 125. In some implementations, the other mobile communications devices 125 need not be associated with other subscribing users. Any number of mobile communications devices 115 can be included in computing environment 100. As the number of mobile communications devices 115 increases, server 105 and network 110 can be scaled, e.g. by adding additional resources, to provide an acceptable level of service. A mobile communications device 115 can be any mobile device configured to communicate over the network 110 with a host service provider, e.g. server 105. For instance, a mobile communications device 115 can be a mobile telephone that is adapted to transmit and receive data communications, e.g., a smart phone, a personal digital assistant, a tablet computing device, a mini-computer, a micro-computer, a notebook computer, a laptop, or any other such computing device.

A mobile communications device 115 further can include a non-transitory data storage device configured to receive and store media content as well as store programmed instructions for providing a multi-level application program as will be described below. The data storage device can be adapted to provide secure storage for the media content, as well as to perform digital rights management functions, e.g. decrypting media content for playback on the mobile communications device 115. In some implementations, the data storage device can be a removable device, e.g. a flash memory module. Thus, a local media library can be stored across multiple data storage devices, which can be swapped to provide access to different portions of the library.

A mobile communications device 115 also can include a display, e.g. a liquid crystal display (LCD) or a light emitting diode (LED) display, and one or more user input devices, such as a touch screen (resistive or capacitive), a touch pad, one or more buttons, one or more keys, a scroll wheel, a dial, a switch, a microphone, or any other such input device. Further, a mobile communications device 115 can be adapted to communicate using one or more protocols, such as 3G, Wi-Fi, Wi-Max or other such protocols. For instance, a mobile communications device 115 can be configured to communicate over Wi-Fi when possible and otherwise to use a 3G connection.

Additionally, computing environment 100 can include one or more computing systems 120. A computing system 120 can be implemented using a computing device, such as a desktop computer, a laptop computer, a notebook computer, a net book, a tablet computing device, a workstation, and a server. Computing system 120 also can be configured to transmit and receive data over network 110, e.g. over a TCP/IP connection. Thus, computing system 120 can be adapted to provide data communications with server 105. For instance, computing system 120 can be used to perform functions relating to a subscribing user's account, such as account management and the selection of media.

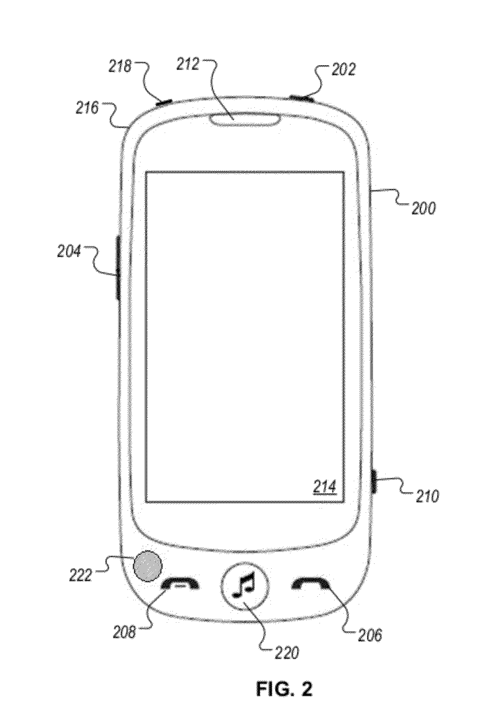

FIG. 2 shows an exemplary mobile communications device. Mobile communications device 200 can be configured to provide wireless voice communication and data communication. The device 200 can include physical controls, e.g. a power button 202, a volume control 204, a phone button 206, an end call button 208, and a camera button 210. Further, the device 200 can include outputs, such as speaker 212 and display 214, which can be a touch sensitive display, e.g. resistive or capacitive. Display 214 can be configured to sense either or both of simple gestures (e.g., touching, swiping) and complex gestures, such as multi-touch gestures.

In some implementations, the device 200 also can include one or more additional speakers 216 to provide for additional audio output. The one or more speakers can be located on any or all of the peripheral edges, the back, and the front of the device 200. One or more of the included speakers, e.g. the one or more speakers 216, can be used to implement audio playback and/or speakerphone functionality. An accessory jack 218, e.g. for headphones, also can be included. Further, the device 200 can have an integrated digital signal processor (DSP) that can provide for customized tuning of audio output. For example, the DSP can be adapted to provide a graphic equalizer, e.g. a five-band equalizer, to allow pinpoint sound control, and a dynamics processor to provide multi-band compression and limiting. One or more preconfigured options and one or more custom options can be used to specify the audio levels for each of the equalizer's bands. Compression can be configurable using predetermined levels, e.g. off, low, medium and high, which can correspond to software configured bundles of parameters for the compressor's various level, ratio, attack and decay parameters for each band. Also, one or more frequencies that cannot be reproduced by a given output device, e.g. the integrated speaker(s), can be rolled-off. Further, high-frequencies can be accentuated and the compressor can be switched into a mode to compensate for background noise. In some implementations, the DSP can be utilized for audio processing with respect to telephone communications, in addition to audio playback.

Additionally, the device 200 can include a media button 220, which can be used to access media functionality. In some implementations, the media button 220 can be a multi-function button. For instance, a single press of the media button 220 can toggle the display between a media playback interface and the phone interface. Further, pressing and holding the media button 220 can cause an interface corresponding to the media service, e.g. a home menu, to be presented. The device 200 can be configured such that accessing the media button 220 causes the corresponding media functionality to be presented, regardless of the previous function being performed and location within the device's command hierarchy. In some implementations, the functionality corresponding to media button 220 also can be state dependent. For instance, when media is playing, pressing the media button 220 can cause a music player interface to be displayed, while pressing and holding can cause the home screen of a remote media catalog (or store) to be displayed. The device 200 also can include physical controls for other functions, including volume and traversing back in the interface.

Also, in some implementations, a back button 222 can be included on the device 200. When the back button 222 is included as a physical control on the device 200, software operating on the device 200 can allow a user to return to a preceding interface screen, upon pressing the back button 222.

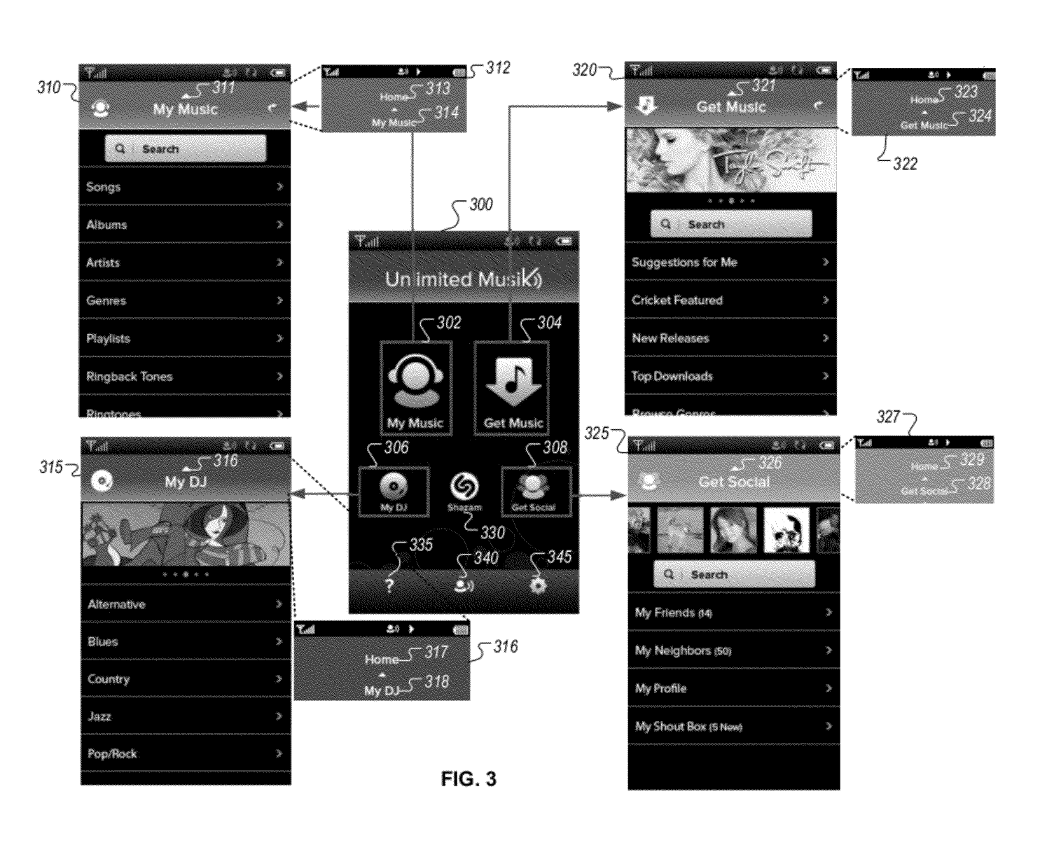

FIG. 3 shows exemplary media interface screens associated with a multi-level media application that can be presented by a mobile communications device. A home media interface screen 300 can be presented, which represents a top level of the multi-level application. The top level screen can show the name of the application, which in the example shown is “Unlimited Musik.” At the top level, the user has access to several functional areas within the media application as well as access to one or more utilities. In the embodiment shown, the home media interface screen 300 includes a number of selectable icons corresponding to the various functional areas, including a “MyMusic” icon 302, a “GetMusic” icon 304, a “MyDJ” icon 306, and a “GetSocial” icon 308. An icon can be selected (or actuated) through any known technique, including through touch and cursor designation. The icons presented are representative and other implementations can include fewer, more, and/or different icons.

The MyMusic icon (or button) 302 can be selected to present a local media interface screen 310, which can provide access to, and browsing of, the local media archive stored on the mobile communications device. The local media interface screen 310 includes a list of controls that can be selected by a user in order to navigate their way to different levels in the application. Each level allows the user to view the local media according to different criteria such as by song name, album name, artist name, genre of music, playlists, ringtones, and ringback tones. One or more other categories also can be included, such as music videos, television shows, and movies. Selecting an entry from the list presented on the local media interface screen 310 can cause the application to present another level interface screen, hierarchically organized as a sub-interface. The new interface screen shows either the stored media corresponding to that category or a further list of selections to allow a user to filter the local media archive by additional criteria. The local media interface screen 310 also can include a search tool, which can be used to search the local media archive, e.g. using keyword searching.

The GetMusic icon 304 can be selected to present a remote media interface screen 320, corresponding to a remote music archive or media store. The remote media interface screen 320 includes a list of controls that are selectable by the user to access and browse the remote media archive according to different criteria. For instance, the remote media interface screen 320 includes one or more controls that allow the user to navigate to screens where the user can view the available media by song title, album title, artist name, genre, playlists, ringtones, and ringback tones. The remote media interface screen 320 also can include one or more other controls to allow the user to navigate to other interface screens showing personalized suggestions, featured media, new releases, and top downloads, e.g. for a predetermined period of time, such as a day, week, or month. Selecting a control from the remote media interface screen 320 can cause the application to present another level interface screen, hierarchically organized as a sub-interface. The new interface screen can show media corresponding to the selected category or a list of selections to allow the user to filter the media items stored at the remote media archive by additional criteria. The remote media interface screen 320 also can include a search tool, which can be used to search the remote media archive, e.g. using keyword searching.

The MyDJ icon 306 can be selected to present a playlist interface screen 315, which provides a list of controls that can be selected by the user to access and browse the playlists available to the mobile communications device. The playlists can include either or both of local playlists, e.g. generated by the user of the device, and remote playlists that are generated by an external provider, such as another user or the system operator. The playlist interface screen 315 includes a list of controls that allow the user to navigate to screens where the user can view the playlists by category, such as genre, content, and playlist source. For instance, the playlists can be viewed using genres such as alternative, blues, country, jazz, and pop/rock. Selecting a control from the playlist interface screen 315 can cause the media application to present another level interface screen, hierarchically organized as a sub-interface, that shows playlists corresponding to that category or another set of selections. In some implementations, the playlists shown can include playlists that are presently available, e.g. local playlists and subscribed playlists, and playlists that are not presently available but can be subscribed to. Further, the playlists that are presently available can be visually distinguished from those that are not, such as through highlighting or through the association of a graphical identifier.

The GetSocial icon 308 can be selected by the user to present a social interface screen 325, which can provide access to the subscriber's community. The community can include connected friends who also are subscribers to the media service, identified neighbors, and a Shout box that provides access to messaging within the media application and service. Further, the social interface screen 325 can provide access to the subscriber's profile, which can be used to describe and publicize subscriber characteristics, including musical preferences and the subscriber's local media archive. The social interface screen 325 also can include a search tool, which can be used to search the subscriber's social connections, e.g. using keyword searching.

Additionally, home media interface screen 300 can present one or more utility icons, which can be selected to perform operations corresponding to the media application. For instance, a music recognition icon 330 can be selected to capture audio and submit it to a music recognition service. Also, a help icon 335 can be selected to access help, e.g. instructions or demonstrations, relating to one or more features and functions of the media application. A help interface organized by topics, such as functions, can be presented in response to selection of the help icon 335. In some implementations, a full tutorial for the media application also can be accessed.

The Shout icon 340 can be selected to access a Shout interface presenting the subscriber's Shout message box. The Shout message box can include Shout messages to and between all members of the subscriber's community. Further, the Shout interface can include an option to view only Shouts addressed to the subscriber and/or sent by the subscriber. Additionally, the home media interface 300 can include a settings icon 345, which can be selected to view and alter one or more device and media application settings, including synchronization status settings, social settings, card settings, and parental controls.

A navigational prompt (e.g., a user selection element, such as a button) can be provided on each of the user interface screens 310, 315, 320 and 325 to shows the subscriber his/her location in navigation tree (or hierarchy) within the multi-level media application regardless of the subscriber's location (or node in the navigation tree) within the multi-level media application (e.g., multi-level application represented by the home media interface screen 300.) The subscriber navigation using the navigational prompt is not limited to navigating through media contents but rather can be applied to all levels and areas in the multi-level media application and can be organizationally depending on the present location of the subscriber within a navigation tree. The navigational prompt provides multiple actuation options for the subscriber. A single click on the navigational prompt navigates the user one lever higher the navigation tree. A click-and-hold actuation (or a multi-click or other actuations different from the single click) reveals the entire hierarchy in the present navigational path (e.g., navigation tree).

For example, a single click actuation on a navigational prompt 311 on the MyMusic interface 310 navigates the user one level up the navigation tree and back to the home interface 300. A click-and-hold actuation on the navigational prompt 311 displays a navigation tree (e.g., a hierarchical flow) 312 within the current navigational path with subscriber selectable options 313 and 314. The displayed navigation tree 312 displays the entire navigational path in the hierarchy starting from the current location (or node in the navigation tree) of the subscriber to allow the subscriber to directly access any node or location in the navigation tree without having to move one level at a time. Because the MyMusic interface 310 is only one level below the home functional area in the MyMusic hierarchy, the subscriber has two selectable options, MyMusic 314 (to remain on the MyMusic interface 310) and Home 313 to navigate directly to the home interface 300.

Similarly, a single click actuation on a navigational prompt 316 on the MyDJ interface 315 navigates the user one level up the hierarchy and back to the home interface 300. A click-and-hold actuation on the navigational prompt 316 displays a navigation tree 316 within the current navigational path with subscriber selectable options 317 and 318. The displayed navigation tree 316 displays the entire navigational path in the hierarchy starting from the current location (or node in the navigation tree) of the subscriber to allow the subscriber to directly access any location or node in the navigation tree without having to move one level at a time. Because the MyDJ interface 315 is only one level below the home functional area in the MyDJ hierarchy, the subscriber has two selectable options, MyDJ 318 (to remain on the MyDJ interface 315) and Home 317 to navigate directly to the home interface 300.

Also, a single click actuation on a navigational prompt 321 on the GetMusic interface 320 navigates the user one level up the hierarchy and back to the home interface 300. A click-and-hold actuation on the navigational prompt 321 displays a navigation tree 322 within the current navigational path with subscriber selectable options 323 and 324. The displayed navigation tree 322 displays the entire navigational path in the hierarchy starting from the current location of the subscriber to allow the subscriber to directly access any area in the hierarchy without having to move one level at a time. Because the GetMusic interface 320 is only one level below the home functional area in the GetMusic hierarchy, the subscriber has two selectable options, GetMusic 324 (to remain on the GetMusic interface 320) and Home 323 to navigate directly to the home interface 300.

In addition, a single click actuation on a navigational prompt 326 on the GetSocial interface 325 navigates the user one level up the hierarchy and back to the home interface 300. A click-and-hold actuation on the navigational prompt 326 displays a navigation tree 327 within the current navigational path with subscriber selectable options 328 and 329. The displayed hierarchical flow 327 displays the entire navigational path in the hierarchy starting from the current location (or node in the navigation tree) of the subscriber to allow the subscriber to directly access any location or node in the navigation tree without having to move one level at a time. Because the GetSocial interface 325 is only one level below the home functional area in the GetSocial hierarchy, the subscriber has two selectable options, GetSocial 328 (to remain on the GetSocial interface 325) and Home 329 to navigate directly to the home interface 300.

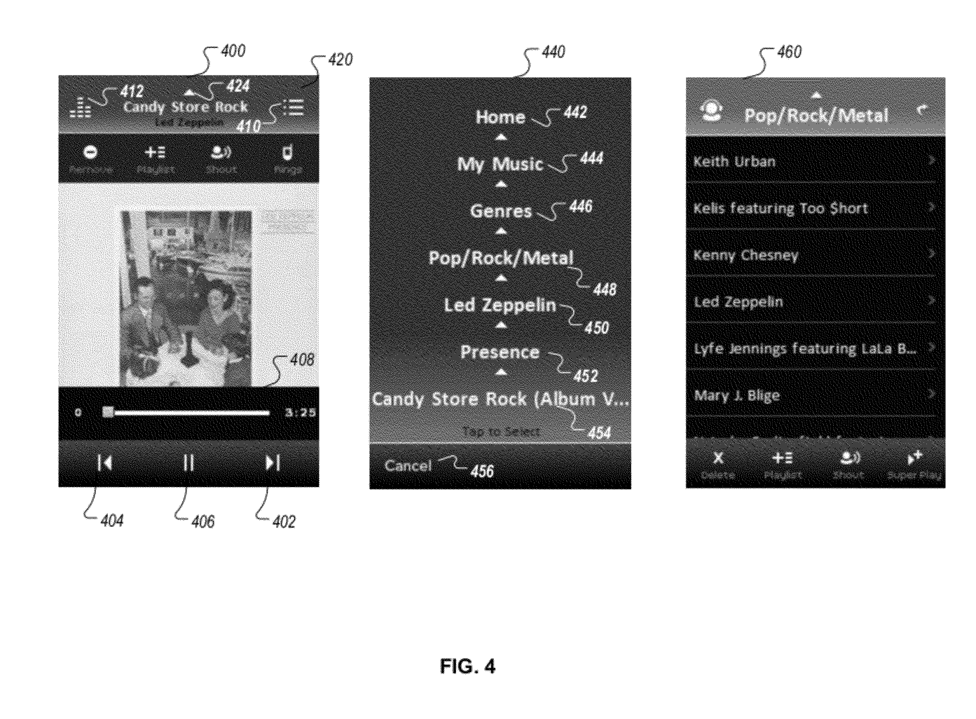

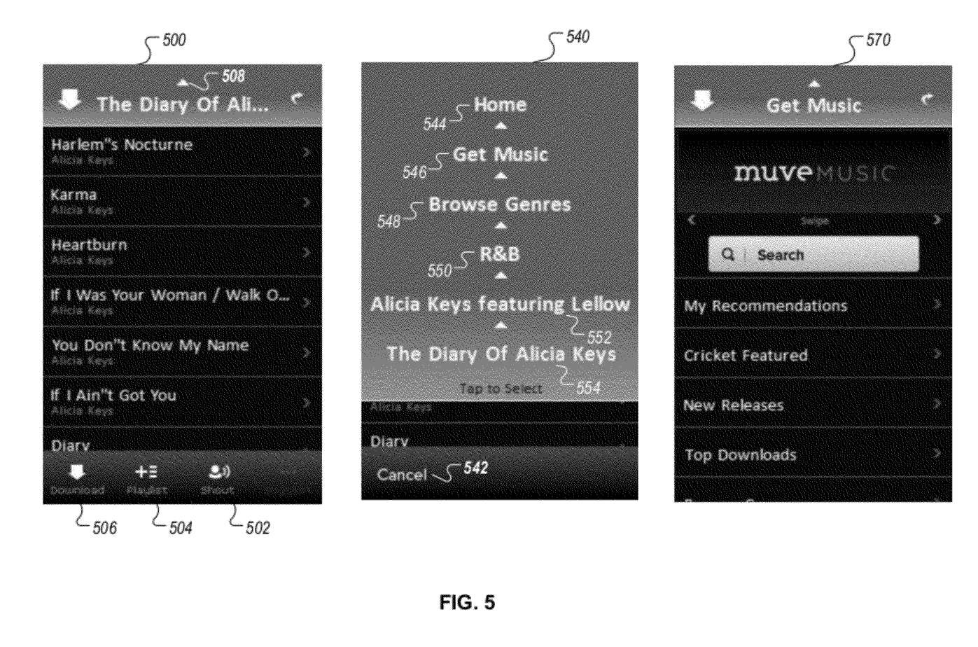

FIGS. 4 and 5 show exemplary navigation interface screens associated with a multi-level media application in accordance with an embodiment of the disclosed technology. The media application is configured to permit a user to determine, from any or all of the individual screen level interfaces, their present level within the application and to transition to a new level in the application without traversing one or more intervening levels. In FIG. 4, a playback interface screen 400 can be presented during playback of an item of media content, e.g. a song such as “Candy Store Rock” by the band Led Zeppelin. The playback interface screen 400 can include one or more playback controls, such as a fast forward (or seek) control 402, a rewind control 404 and play/pause control 406. In addition, the playback interface screen 400 may include a media timeline 408 to indicate how much of the currently accessed media file has been played and how much remains.

The playback interface screen 400 can also include a title bar 420, that presents artist and title information, and one or more control icons, including a navigation prompt 424. In the embodiment shown, the navigation prompt 424 shares the title bar with other icons that provide access to other controls, such as a list icon 410 and a graphic equalizer icon 412. Selecting the navigation prompt 424, e.g. using touch or cursor input, can cause the media application to present a navigation interface 440 either as an overlay or as an expanded menu on the current level interface screen 400 (i.e., the playback interface screen in the example shown). Alternatively, the navigation interface 440 can be presented as a new interface screen.

The navigation interface 440 presents the user with a representation of a navigation tree within the multi-level media application, including the present location (or node) within the navigation tree. In some implementations, the navigation tree can be presented as a list where each entry in the list operates as a control to allow the user to navigate directly to that level of the media application. The entries in the list can be physically arranged such that the control 442 to navigate to the top level is shown at the top of the list, a control 454 to return to the current level is positioned at the bottom of the list, and the controls to navigate to the intervening levels are positioned in hierarchical order between the top and bottom controls in the list.

In some implementations, one or more of the entries in the list of controls shown in the navigation interface 440 is labeled with a selection that was made in the process of navigating from the top level of the media program to the current level of the program. For example, in the embodiment shown in FIG. 4, the current level interface screen 400 shows that a user has selected the song “Candy Store Rock” performed by the band Led Zeppelin. In this example, the user may have navigated to this level in the application by first selecting the My Music functional area and then selecting a genre control to view the available genres of music. The user may have then selected Pop/Rock/Metal from a number of different genre types, followed by the selection of the band Led Zeppelin from a list of artists that are categorized as playing in the Pop/Rock/Metal genre.

The album Presence was then selected at the Album level in the hierarchy from a list of locally stored albums having content by Led Zeppelin. Finally, the song Candy Store Rock was selected from the number of locally stored songs that are included on the album Presence.

Using the navigation interface 440, the media application can return to any level of the hierarchy upon the selection of a corresponding control in the list. For example, by selecting the control labeled “Pop/Rock/Metal” 448, the media application can present an interface screen 460 that shows other artists classified within this genre, e.g. for which there are locally stored media files.

Additionally or alternatively, selecting the control associated with the current level, e.g. the control labeled 454, can cause the navigation interface 440 to be closed and the previously viewed interface screen to once again be presented. The navigation interface 440 also can include a control 456 labeled “Cancel” that when selected causes the media application to return to the previously presented interface screen.

In other implementations, the entries in the list of controls shown on the navigation interface 440 may be generically labeled with their corresponding hierarchy level. For example, the control 454 that is illustrated as being labeled “Candy Store Rock (Album V . . . ” may instead be labeled “Songs” and the control 452 that is shown as being labeled “Presence” may be labeled “Albums.” In yet other implementations, the controls may be labeled with both the generic hierarchy level and with the selection made at that level while navigating to the current level in the media application.

In yet other implementations, at least some of the entries in the list of navigation controls 442-454 can be labeled with an indication of how the item shown in the current interface screen is classified at one or more levels of hierarchy. This can provide a mechanism for a user to easily view similar items. For example, the control 452 at the Albums hierarchy level is labeled “Presence” because the item viewed in the current playback interface screen (i.e. the song Candy Store Rock) is included on this album. Similarly, the control 450 at the Artist hierarchy level of the media application is labeled “Led Zeppelin” because the version of the song “Candy Store Rock” that was accessed when the navigation prompt was selected was recorded by the band Led Zeppelin. Similarly, the control 448 is labeled “Pop/Rock/Metal” because the band Led Zeppelin is categorized within the Pop/Rock/Metal genre.

The controls shown in the navigation interface 440 in this embodiment are therefore not dependent on how a user has navigated to the currently viewed item. For example, the user may have used the search feature or a menu option to go directly from the top level of the media application to the song level. Rather, the controls shown in the navigation interface 440 illustrate the logical hierarchy between the current level and the top level of the application. For instance, the hierarchy can be defined as top level (home), functional area (My Music), genres, selected genre (Pop/Rock/Metal), selected artist (Led Zepplin), selected album (Presence), and selected track (Candy Store Rock). Thus, even if the track “Candy Store Rock” was selected directly from the My Music functional area or from an intervening songs menu, all of the intervening levels in the logical hierarchy can be shown in the navigation interface 440.

By labeling one or more of the controls with an indication of how the currently viewed item is classified within one of more of the hierarchy levels, a user can find similar items. Upon selection of a control, the media application may present an interface screen that is configured according to the label of the selected control on the navigation interface. For example, to see other songs on the album “Presence”, the control 452 may be selected. In response to the selection, an interface screen may be presented that lists the other songs that are included on the album Presence and are stored in the corresponding archive. Similarly, selection of the control Led Zepplin 450 can cause an interface screen to be presented that shows other albums of the band Led Zeppelin from which at least one song is stored in the corresponding archive.

Further, a color theme can be associated with a functional area within the application and the navigation interface can be displayed using that color. Accordingly, different functional areas within an application can be visually distinguished based on the color associated with a navigation interface. For instance, in one embodiment, the My Music functional area can be designated with a blue color, the Get Social functional area can be designated with an orange color, the Get Music functional area can be designated with a green color, the My DJ playlist handling functional area can be designated with a purple color, and system settings can be designated with a gray color. In other embodiments, one or more of the colors used to designate the functional areas can be different. Further, a navigation feature can be color coded both in its expanded form and in its compressed form. For example, both the navigation prompt 424 and the navigation interface 440 can be color coded using the same color, e.g. blue, so that the associated functional area can be identified when either navigation feature is presented.

FIG. 5 illustrates another exemplary set of interface screens for levels associated with the Get Music functional area of the application. In the example shown, an interface screen 500 presents a current media item namely, the album “Diary of Alicia Keys” by the artist Alicia Keys. Thus, the album level is the current level within the application hierarchy. The interface screen 500 shows a list of the individual songs included on the album. An entry for a song in the interface screen 500, such as the song “Heartburn”, can be visually distinguished from other entries, e.g. by displaying the entry in a different color or otherwise marking the entry, to indicate that the song already is stored in the user's local media archive. The interface screen 500 can include a control 502 labeled “Shout” that when selected, can cause the media application to generate a shout message about the item selected by the user (e.g. a song on the The Diary of Alicia Keys album). A control 504 labeled “Playlist” can be selected to cause the media application to add one or more selected songs to a playlist. Further, a control 506 labeled “Download” can be selected to cause the media application to request one or more selected songs to be downloaded.

The interface screen 500 also can include a navigation prompt 508 that is located, for example, in the title display bar. The navigation prompt 508 is selectable by a user to generate a navigation interface 540 either as an overlay on the current interface screen or as a new interface screen. The navigation interface 540 contains a list of controls that are selectable to navigate to a new level in the application.

Each of the controls in the navigation interface 540 can be labeled according to the selections made to navigate to the current level in the hierarchy. For example, the user may have selected the functional area Get Music, followed by selecting to view different genres. The user may have then selected R&B as a genre to browse, followed by selecting Alicia Keys as an artist. Finally, the user may have selected to view The Diary of Alicia Keys. Despite the navigation path taken, the media application can be navigated to any level of the hierarchy upon the selection of a corresponding control on the list of controls shown on the navigation interface 540. For example, if the control 546 is selected, the media application can present the interface screen 570 that corresponds to an interface presented when the Get Music functional area is selected from the home screen.

A cancel control 542 also can be selected to cause the media application to close the navigation interface 540. Additionally or alternatively, the control associated with the current level, e.g. the control 554 labeled “The Diary of Alicia Keys” can be selected to close the navigation interface 540 and to return to the current interface screen 500.

In some implementations, the classification of each media file or item presented in a current display screen is associated with a record, code, string or the like that indicates how the controls in the navigation interface should be labeled if the user selects the navigation prompt when viewing that media file or item. In some other implementations, the classification of each hierarchical level in the navigation menu can be determined based on a standard hierarchy associated with the application and the currently selected level within the application.

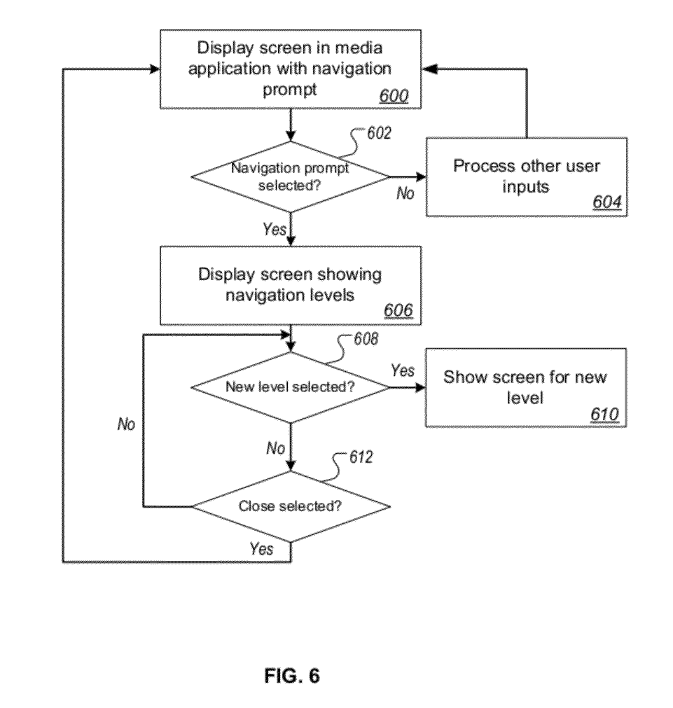

FIG. 6 illustrates a flow diagram of steps performed by processor electronics within a mobile communication device for allowing a user to navigate between levels of an application, such as a media application. Although the steps are described in an order for ease of explanation, it will be appreciated that the steps could be performed in a different order or different steps performed while still obtaining the functionality described.

Beginning at 600, a processor executes programmed instructions to present an interface display screen in a media application, the interface including a navigation prompt. The navigation prompt can be shown in a title bar associated with the interface screen. Alternatively, the navigation prompt can be displayed in one or more other areas of the interface screen, on other areas of the display screen, or can be activated by a separate physical button or control. Alternatively, the navigation prompt can be a software controlled function that responds to input from a user, such as a gesture made on the display screen, a voice command, or other such input.

At 602, the processor can determine if the user has selected the navigation prompt. If not, at 604 the processor can process other user inputs or selections, or await user input. If the user has selected the navigation prompt, at 606, a navigation interface can be generated showing a list of controls that can be selected to navigate to a different level of the application and to result in the presentation of a new interface screen corresponding to that level of the application. In some implementations, each control in the list can be labeled according the selections made by a user to navigate to the current level in the application. For instance, the navigation interface can include a control associated with a home (or top) level of the application, a control associated with the current level of the application, and, if any intervening levels exist, a control associated with one or more intervening levels.

In some other implementations, each control in the list can be labeled in accordance with a hierarchical structure of the application, so that the list includes the present level, the home level, and any intervening levels as defined by the hierarchy. For instance, although it can be possible to select the song level directly from an archive level interface, e.g. the MyMusic level, the navigation interface also can include one or more logically intervening levels, such as a genre level, an artist level, and/or an album level.

At 608, the processor can determine if a user has selected a control from the list of controls on the navigation interface. If so, the processor can present a new interface screen corresponding to the selected application level at 610. For example, if a control labeled “Led Zeppelin” is selected within the My Music functional area, an interface screen can be presented showing all of the available albums associated with Led Zeppelin for which content is locally stored. Alternatively, if the user selects a control labeled “Country” at the genre level of the My Music functional area, then the processor can present an interface screen showing all of the artists having content stored locally who are classified in the country genre. If the user has not selected an entry, the processor determines if the user has selected the close control at 612. If the user has not selected the close control at 612, processing returns to 608 until the processor detects that the user selects an entry in the list to navigate to a new level or selects the close control. Alternatively or additionally, the processor can determine whether the navigation interface has been open for a predetermined amount of time and, if so, can automatically close the navigation interface and return to presenting the interface from which it was called.

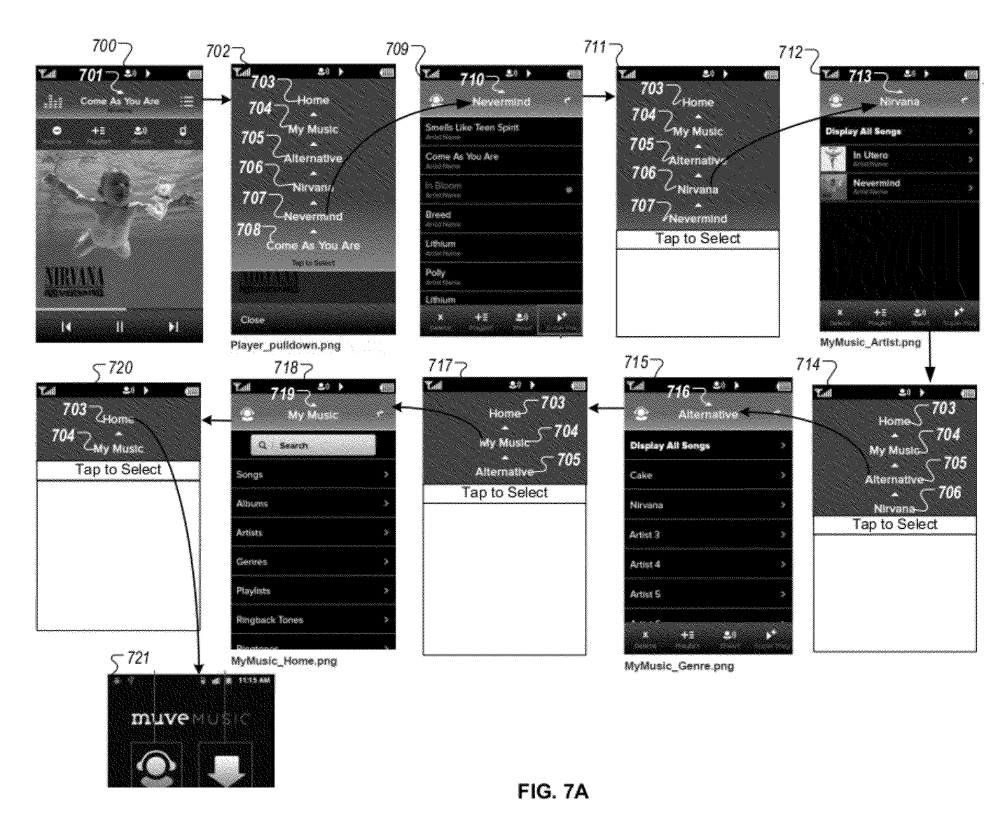

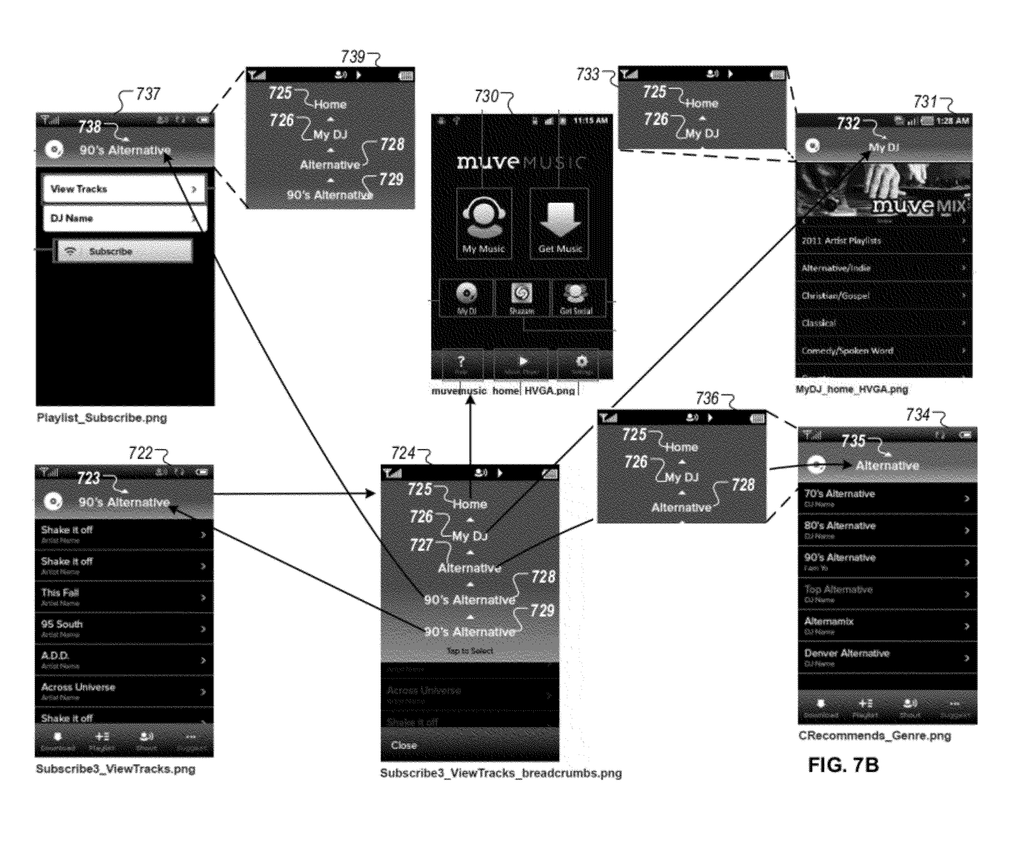

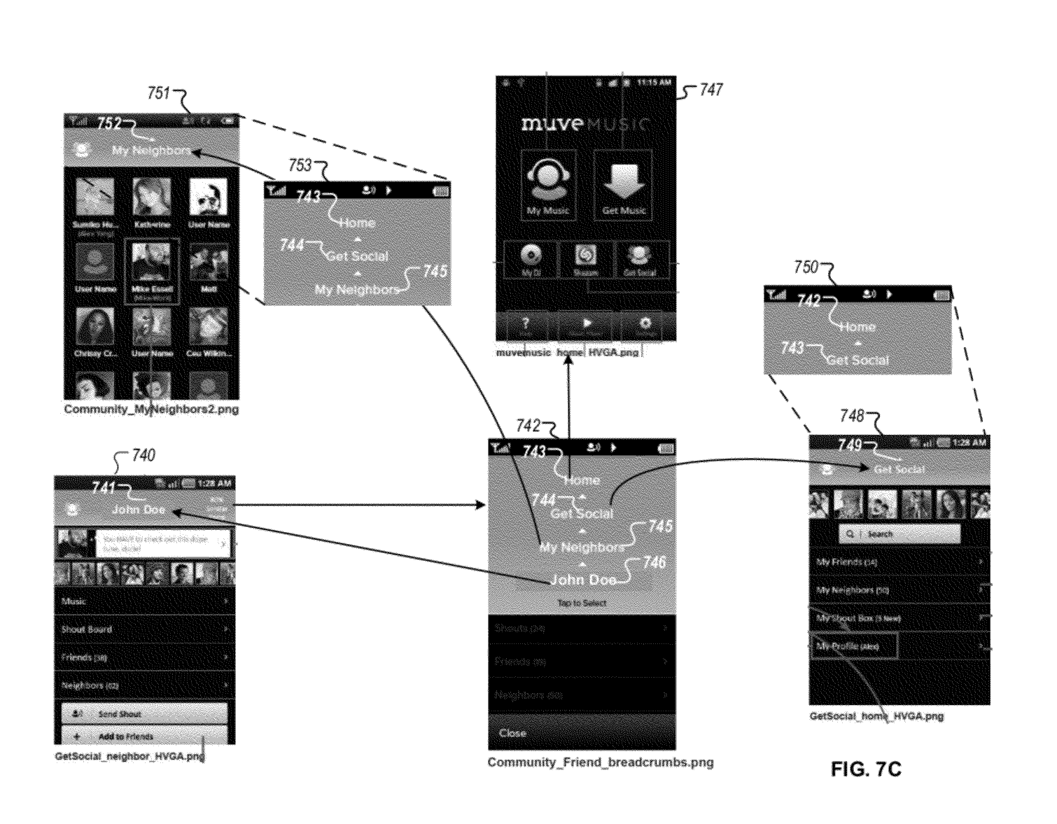

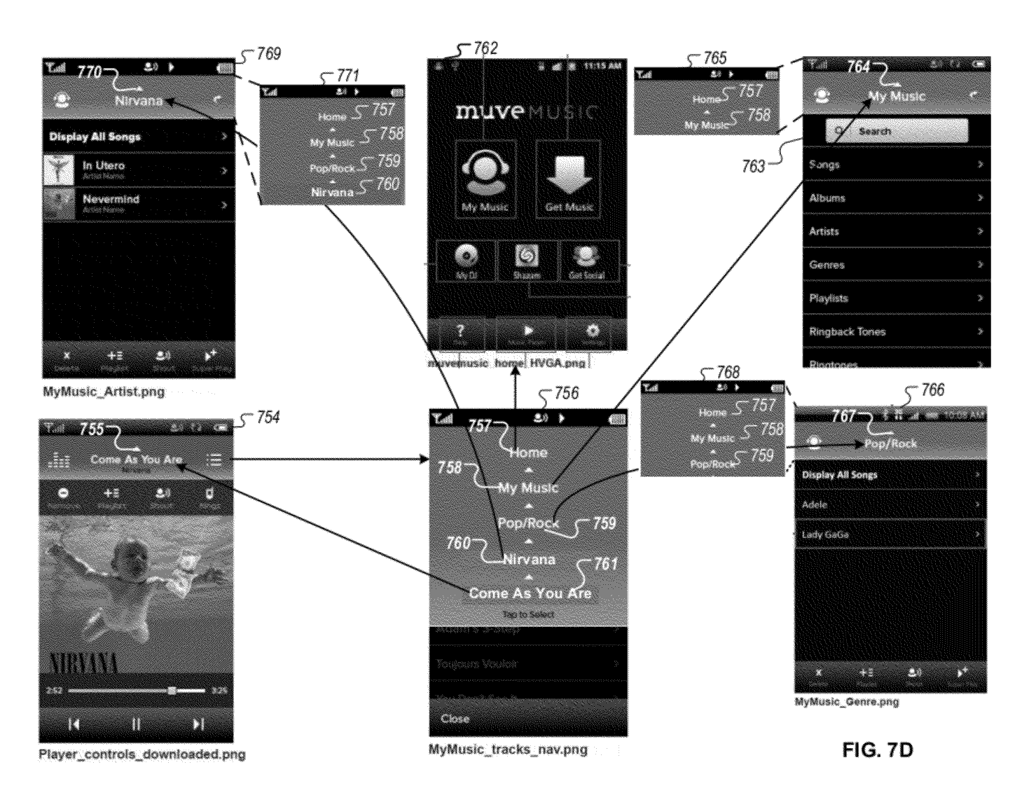

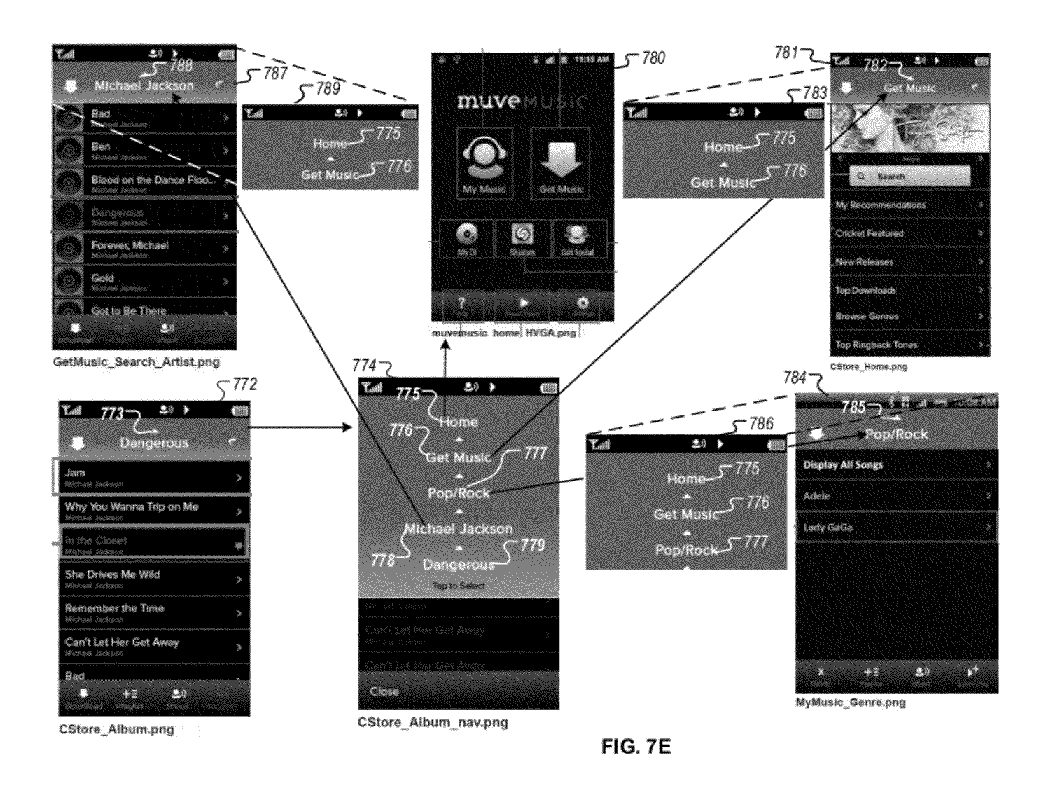

FIGS. 7A, 7B, 7C, 7D and 7E show exemplary navigations within various multi-level applications. For example, FIG. 7A shows hierarchical navigations within multiple levels of a media player application. A subscriber playing a media content item (e.g., a song entitled ‘Come As You Are.’) on a media player interface 700 can view a navigation tree by actuating a navigation prompt 701 to visually identify all nodes (e.g., locations) in the navigation tree that the subscriber can access directly. As described with respect to FIG. 3 above, the navigational prompt (e.g., a user selection element, such as a button) 701 can provide multiple actuation options for the subscriber. A single click on the navigational prompt 701 navigates the user one lever higher the navigation tree. A click-and-hold actuation (or a multi-click or other actuations different from the single click) reveals the navigation tree.

In the example shown in FIG. 7A, when the subscriber clicks and holds on the navigation prompt 701, a navigation tree 702 is displayed. The navigation tree 702 shows all nodes 703, 704, 705, 706, 707, and 708 that the subscriber can access directly. User actuation of any of the nodes 703, 704, 705, 706, 707, and 708 navigates the subscriber to the corresponding user interface. The navigation tree 702 in FIG. 7A shows that the user is at a song level (e.g., listening to ‘Come As You Are.”) From there, the subscriber can access the album level node 707 (the album Nevermind in this example), the artists level node 706 (the artists Nirvana in this example), the genre level node (Alternative Music genre in this example), the MyMusic node 704, and the Home node 703.

The navigation tree 702 allows the subscriber to directly access any node or location. For example, user actuation of the album level (e.g., Nevermind) navigates the user to that node and the associated album entitled ‘Nevermind.’ Once in the album node for the album Nevermind 709, the subscriber can actuate (click-and-hold) a navigation prompt 710 to displays a navigation tree 711, which is different from the navigation tree 703 because the subscriber's location in the hierarchy has changed. As shown in the navigation tree 711, the lowest level is now the album Nirvana. The remaining nodes shown in the navigation tree 711 are higher up the hierarchy than the present location of the user.

User actuation of artist (in this example, Nirvana) button 706 From the album interface (e.g., album Nirvana) navigation tree 711 or any other navigation tree navigates the user to a Nirvana album user interface 712. The Nirvana album user interface 712 includes a navigation prompt 713 the subscriber can use to display the navigation tree 714, which has changed from navigation tree 711. The subscriber is now at the artist level (e.g., Nirvana), and the navigation tree 714 shows four nodes: Home 703, MyMusic 704, Alternative 705 and Nirvana 706. User actuation (click an hold) of the alternative genre node 705 on the navigation tree 714 navigates the user to the alternative genre interface 715 within the MyMusic functional area. The user can actuate the navigation prompt 716 to display a navigation tree 717, which is different from the navigation tree 714. Because the subscriber is now at the genre level node, the only three nodes are shown in the navigation tree 717: home 703, MyMusic 704 and alternative genre 705.

Subscriber actuation of MyMusic 704 node navigates the subscriber to the MyMusic interface 718. The subscriber can actuate the navigation prompt 719 to display a navigation tree 720, which is different from the navigation tree 717. The subscriber location in the hierarchy has changed to the MyMusic node, and thus only two nodes are available for direct user access: home 703 and MyMusic 704. Subscriber actuation of the home node button 703 navigates the user to the home interface 721.

FIG. 7B shows exemplary hierarchical navigations within multiple levels of a MyDJ (e.g., a playlist application.) A subscriber browsing playlists on a playlist interface 722 can actuate (e.g., click-and-hold) a navigation prompt 723 to display a navigation tree 724. The navigation tree 724 associated with MyDJ shows 5 nodes in this example: home 725, MyDJ 726, alternative genre 727, 90's alternative genre playlist options 728, and 90's alternative genre playlist 729. The navigation tree 724 allows the subscriber to view all nodes in the tree that the subscriber can directly access. For example, subscriber actuation of the home node button 725 navigates the user to the home user interface screen 730. Subscriber actuation of MyDJ node button 726 navigates the user to the MyDJ user interface screen 731. The subscriber can actuate a navigation prompt 732 to display the navigation tree 733, which is different form the navigation tree 724 because the subscriber's location in the hierarchy has changed.

Subscribe actuation (e.g., e.g., click-and-hold) of the alternative genre button 727 navigates the subscriber to the alternative genre interface 734 within the MyDJ functional area. Subscriber actuation (e.g., e.g., click-and-hold) of a navigation prompt 735 displays a navigation tree 736, which is different from the navigation tree 724 because the subscriber has changed location to the genre level. The navigation tree 736 shows three user selectable options: home 725, MyDJ 726 and Alternative genre 728. Subscriber actuation of the 90's alternative genre button 728 navigates the subscriber to the 90's alternative genre options interface 737. The subscriber can actuate (e.g., click-and-hold) on a navigation prompt 737 to display a navigation tree 739, which has changed from navigation trees 724, 733, and 736 because the subscriber has moved to a different location or node in the navigation tree. The navigation tree 739 shows four nodes: home 725, MyDJ 726, Alternative 728 and 90's alternative 729.

FIG. 7C shows exemplary hierarchical navigations within multiple levels of a GetSocial (e.g., a social networking and media content sharing) application. A subscriber browsing another subscriber (e.g., John Doe) user interface 740 within the GetSocial functional area can actuate (e.g., click-and-hold) a navigation prompt 741 to display a navigation tree 742. The navigation tree 742 associated with John Doe user interface shows 4 nodes in this example: home 743, GetSocial 744, My Neighbors 745, and John Doe 746. The navigation tree 742 allows the subscriber to view all nodes in the tree that the subscriber can directly access. For example, subscriber actuation of the home node button 743 on the navigation tree 742 navigates the user to the home user interface screen 747. Subscriber actuation of GetSocial node button 744 navigates the user to the GetSocial user interface screen 748. The subscriber can actuate a navigation prompt 749 to display the navigation tree 750, which is different form the navigation tree 742 because the subscriber's location in the hierarchy has changed.

Subscriber actuation (e.g., e.g., click-and-hold) of the My Neighbors node button 745 navigates the subscriber to the MyNeighbors user interface 751 within the GetSocial functional area. Subscriber actuation (e.g., e.g., click-and-hold) of a navigation prompt 752 displays a navigation tree 753, which is different from the navigation tree 742 because the subscriber has changed location to the My Neighbors level. The navigation tree 753 shows three user selectable options: home 743, GetSocial 744 and my neighbors 745. The subscriber can directly access any and all of the nodes in the navigation tree. No matter where the subscriber is located, actuating the navigate button (e.g., 740) allows the subscriber to automatically access those information.

FIG. 7D shows exemplary hierarchical navigations within multiple levels of a MyMusic (e.g., media content managing) application. A subscriber browsing and/or playing a song ‘Come As You Are’ through the media player user interface 754 within the MyMusic functional area can actuate (e.g., click-and-hold) a navigation prompt 755 to display a navigation tree 756. The navigation tree 756 associated with the media player user interface shows 5 nodes in this example: home 757, MyMusic 758, Pop/Rock genre 759, albums (e.g., Nirvana) 760 and a media player interface 761. The navigation tree 756 allows the subscriber to view all nodes in the tree that the subscriber can directly access. For example, subscriber actuation of the home node button 757 on the navigation tree 756 navigates the user to the home user interface screen 762. Subscriber actuation of MyMusic node button 758 navigates the subscriber to the MyMusic user interface screen 763. The subscriber can actuate a navigation prompt 764 to display the navigation tree 765, which is different from the navigation tree 742 because the subscriber's location in the hierarchy has changed.

Subscriber actuation (e.g., e.g., click-and-hold) of the Pop/Rock genre node button 759 navigates the subscriber to the Pop/Rock user interface 766 within the MyMusic functional area. Subscriber actuation (e.g., e.g., click-and-hold) of a navigation prompt 767 displays a navigation tree 768, which is different from the navigation tree 756 and 765 because the subscriber has changed the location to the My Neighbors level. The navigation tree 768 shows three user selectable options: home 757, MyMusic 758 and Pop/Rock genres user interface 766. Subscriber actuation (e.g., e.g., click-and-hold) of the Nirvana (e.g., artist) node button 760 navigates the subscriber to the artist (e.g., Nirvana) user interface 769. Subscriber actuation of a navigation prompt 770 displays a navigation tree 771, which is different from the navigation trees 756, 765 and 768. This is because the subscriber has changed his/her location or node in the hierarchy. The navigation tree 771 displays four nodes: home 757, MyMusic 758, Pop/Rock genre 759, and Nirvana 760.

FIG. 7E shows exemplary hierarchical navigations within multiple levels of a GetMusic (e.g., media content store and/or catalog) application. A subscriber browsing an album (e.g., ‘Dangerous’ by Michael Jackson) through the albums user interface 772 within the GetMusic functional area can actuate (e.g., click-and-hold) a navigation prompt 773 to display a navigation tree 774. The navigation tree 774 associated with the media player user interface shows 5 nodes in this example: home 775, GetMusic 776, Pop/Rock genre 777, artist name (e.g., Michael Jackson) 778 and album for that artist 779. The subscriber can actuate any of the choices from the navigation tree 774 in any order. The navigation tree 774 allows the subscriber to view all nodes in the tree that the subscriber can directly access. For example, subscriber actuation of the home node button 775 on the navigation tree 774 navigates the user to the home user interface screen 780. Subscriber actuation of GetMusic node button 776 navigates the subscriber to the GetMusic user interface screen 781. The subscriber can actuate a navigation prompt 782 to display the navigation tree 783, which is different from the navigation tree 774 because the subscriber's location in the hierarchy has changed. From the GetMusic location or node, the subscriber now has two nodes that he/she can navigate to: home 775 and GetMusic 776 (to remain on GetMusic functional area). When the user moves to a different node, a different navigation tree will be displayed.

Subscriber actuation (e.g., e.g., click-and-hold) of the Pop/Rock genre node button 777 navigates the subscriber to the Pop/Rock user interface 784 within the GetMusic functional area. Subscriber actuation (e.g., e.g., click-and-hold) of a navigation prompt 785 displays a navigation tree 786, which is different from the navigation tree 774 and 783 because the subscriber has changed the location to the Pop/Rock genre level. The navigation tree 786 shows 3 user selectable options: home 775, GetMusic 776, and Pop/Rock genre 777. Subscriber actuation of the artist name (e.g., Michael Jackson) node button 778 from the navigation tree 774 navigates the subscriber to the artist name (e.g., Michael Jackson) user interface 787. Subscriber actuation of a navigation prompt 788 displays a navigation tree 789, which is different from the navigation trees 774, 783 and 786. This is because the subscriber has changed his/her location or node in the hierarchy or navigation tree. The navigation tree 788 displays four nodes: home 757, MyMusic 758, Pop/Rock genre 759, and Nirvana 760.

In this document, when describing that two or more navigation trees are different from one another, the difference can include: 1) while displaying the same hierarchy or navigation path, different number of nodes are shown based on the current location of the subscriber; and/or 2) different hierarchies or navigation paths are shown based on the different between the previous location and the current location of the subscriber.

The subscriber can directly access any and all of the nodes in the navigation tree. No matter where the subscriber is located, actuating the navigate button (e.g., 740) allows the subscriber to automatically access those information. Using the navigation tree, the system can display to the subscriber, his/her location in the current navigation path hierarchically. The tree navigation can change not based on media content but rather organizationally depending on the current location of the subscriber in the hierarchy. Accordingly the describe hierarchical navigation technology described in this document is a non-directional navigational tool that can provide direct access to any node in the navigation free from the current location of the subscriber.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user (e.g., subscriber), embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include any number of clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

As can been seen from the above, the disclosed technology allows users to easily navigate through a multi-level application without having to sequentially step forwards and backwards through intervening levels of the application.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

What is claimed is:

1. A device comprising:
a display;
an input device configured to receive user input; and
processor electronics configured perform operations comprising:
executing program instructions to provide an application having navigable levels;
generating an interface screen including a navigation prompt for presentation on the display, the interface screen corresponding to a current level of the application;
receiving input from the input device indicating a selection of the navigation prompt;
generating a navigation interface for presentation on the display, the navigation interface including one or more selectable controls, each of the one or more selectable controls corresponding to a level of the application; and
generating an interface screen for a new level in the application upon detecting a selection of a control in the navigation interface.

2. The device of claim 1, wherein the controls on the navigation interface are labeled with selections made to navigate to the current level of the application.

3. The device of claim 1, wherein one or more of the controls on the navigation interface is labeled in accordance with how an item viewed at the current level in the application is categorized according to different levels in the application.

4. The device of claim 3, wherein upon detecting the selection of the control in the navigation interface, the processor is configured to present an interface screen at the corresponding level of hierarchy, the interface screen being configured according to the label of the selected entry.

5. The device of claim 1, wherein:
the application provides a number of functional areas, each having an associated color scheme; and
wherein the navigation interface created upon selection of the navigation prompt from within a functional area is configured to be displayed using the same color scheme as the corresponding functional area from which the navigation prompt is selected.

6. The device of claim 1, wherein the navigation interface screen includes a control that removes the navigation interface screen from the display and returns a previously viewed interface screen to the display.

7. The device of claim 1, wherein the navigation prompt shares a space with other icons on the display.

8. A non-transitory, computer-readable media containing instructions that are executable by a processor to allow navigation within an application having a number of levels, by:
producing a current interface screen that contains a navigation prompt;
detecting if a user has selected the navigation prompt;
producing a navigation interface having a number of controls, each of which being associated with a level in the application and wherein each control is selectable to navigate to a corresponding level in the application.

9. The non-transitory computer-readable media of claim 8, further including instructions executable by a processor to label one or more of the controls in the navigation interface to correspond with selections made to navigate to a current level of the application.

10. The non-transitory computer-readable media of claim 8, further including instructions executable by a processor to label one or more of the controls in the navigation interface in accordance with how an item viewed at a current level in the application is categorized in one or more levels of the application.

11. The non-transitory computer-readable media of claim 8, further including instructions executable by a processor to produce a new interface screen at a level that corresponds to a selected control in the navigation interface.

12. The non-transitory computer-readable media of claim 11, further including instructions that are executable by a processor to configure the new interface screen in accordance with a label of the selected control.

13. The non-transitory computer-readable media of claim 8, further including instructions that are executable by a processor to display the navigation interface using a color included in a color scheme associated with an interface screen in which a navigation prompt is selected.

14. A method implemented by a processor in a mobile device to allow a user to navigate an application having a number of levels, comprising:
producing a current interface screen representing a current level in the application that contains a navigation prompt;
detecting a selection of the navigation prompt; and
producing, in response to the detected selection, a navigation interface having a number of controls, each of which is associated with a level in the application and wherein each control is selectable to navigate to a corresponding level in the application.

15. The method of claim 14, further comprising labeling the controls of the navigation interface in accordance selections made to navigate to the current level of the application.

16. The method of claim 13, further comprising labeling one or more the controls of the navigation interface in accordance with a classification of an item viewed at the current level in the application according to one or more levels in the application.
